(19) United States
(12) Patent Application Publication
(10) Pub. No.: US 2015/0032475 A1
(43) Pub. Date: Jan. 29, 2015

(54) STORING AND DISTRIBUTING PERSONAL GRID RESULTS IN A CLINICAL SETTING

(71) Applicant: CERNER INNOVATION, INC., Kansas City, KS (US)

(72) Inventors: MARK A. HOFFMAN, Lee's Summit, MO (US); KEVIN M. POWER, Kansas City, MO (US); JOHN DAVID LARKIN NOLEN, Prairie Village, KS (US); TERAH COLLINS, Kansas City, MO (US)

(21) Appl. No.: 14/445,865

(22) Filed: Jul. 29, 2014

Related U.S. Application Data
(60) Provisional application No. 61/859,541, filed on Jul. 29, 2013.

(51) Int. Cl. G06F 19/00; G06Q 30/02

(52) U.S. Cl. CPC G06F 19/322; G06Q 30/0283
USPC 705/3

(57) ABSTRACT

Methods and systems are provided for the communication of personal grid results in a clinical setting. Personal grid results comprise one or more of: 1.) genetic sequences or genetic markers of a genome of the patient, 2.) one or more proteomic profiles of the patient, 3.) one or more genetic sequences or genetic markers of a microbiome of the patient, 4.) one or more transcriptome profiles of the patient, 5.) genetic sequences or genetic markers of a exome of the patient, and 6.) one or more cytogenetic data of the patient. The personal grid results also comprise clinical history, allergies, family history, a belief system, and attributes of the patient. The personal grid results are received by the entity that is responsible for distributing the personal grid results from a first party (or a publisher). The personal grid results are then communicated to a second party (or a subscriber) for a cost. In return, a royalty fee is paid to the first party (or publisher) by the entity responsible for distributing the personal grid results.

### CROSS-REFERENCE TO RELATED APPLICATIONS

This application claims priority to U.S. Provisional Application Ser. No. 61/859,541, filed Jul. 29, 2013, entitled “Storing and Distributing Personal Grid Results in a Clinical Setting,” the disclosure of which is hereby incorporated by reference in its entirety.

### BACKGROUND

“Omics” is a neologism in the English language and informally refers to a field of study in biology ending in —omics, such as genomics, proteomics or metabolomics. “Ome” is a related suffix used to address the objects of study of such fields, such as the genome, proteome or metabolome, respectively. Recent advances in molecular biology and related fields have led to a better understanding of such objects as the genome, proteome, microbiome, transcriptome, and exome. Cytogenetics is much older in the scientific realm, as it was first discovered in the mid 1800's. However, recent advances in molecular cytogenetics have produced much more efficient and more accurate experimental studies. All of these objects of scientific study can lead to a better understanding of a patient's ailment(s) in a clinical setting.

Obtaining information or data regarding the genome, proteome, microbiome, transcriptome, exome and/or cytogenetics of a patient is time consuming and expensive. Furthermore, such data can be conducted at one clinical setting, such as the patient's primary care physician's (PCP's) office, and not be disseminated to other clinical settings. For example, a patient has genomic data obtained at his or her PCP's office and subsequently visits a nearby hospital. Under normal circumstances, the hospital would not know of the genomic data obtained at the patient's PCP's office. Assuming the genomic data is important to the outcome of the patient's health, the hospital would then have to repeat the experiments to obtain the same genomic data that was already obtained at the patient's PCP's office. Embodiments of the current invention help to resolve this issue by collecting all the data regarding genome, proteome, microbiome, transcriptome, exome and/or cytogenetics of a patient and storing these data in one centralized location. In one embodiment, these data can then be disseminated to a subscriber that is interested in some or all of the data available for a particular patient. This implies that the subscriber process involves human intervention. However, this is not always the case, as a key part of the envisioned strategy is that the subscription process involves automated decision support that invokes the—omics information without requiring the user to know that it is available.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. The present invention is defined by the claims.

Embodiments of the present invention provide methods and systems for electronically collecting personal grid results from a first party and providing for the dissemination of results to a requesting second party. In some embodiments, a personal grid results manager (i.e. centralized database; cloud based repository) may be provided for receiving personal grid results and ensuring that the results are communicated to the proper second party. Communication of the results may in some cases entail providing a notification of the availability of results to the second party and requiring the second party to access the results and verify review of the results. A list of results pending review by the second party may also be provided to the entity responsible for distributing the results to the second party.

Embodiments of the present invention relate to coordinating the collection and dissemination of personal grid results. Accordingly, in one aspect, the present invention is directed to one or more computer-storage media storing computer-useable instructions that, when used by one or more computing devices, cause the one or more computing devices to perform a method in a clinical computing environment for communicating a personal grid result for a patient, comprising: receiving the personal grid results for the patient from a first party. The personal grid results comprise one or more of: 1.) genetic sequences or genetic markers of a genome of the patient, 2.) one or more proteomic profiles of the patient, 3.) one or more genetic sequences or genetic markers of a microbiome of the patient, 4.) one or more transcriptome profiles of the patient, 5.) genetic sequences or genetic markers of an exome of the patient, and 6.) one or more cytogenetic data of the patient. The method also includes storing the personal grid results from the first party in a centralized database followed by receiving a request for access to the personal grid results from a second party. Subsequently, a cost for access of the second party to the requested personal grid results is calculating based on the request. The method further includes communicating the cost for the requested personal grid results to the second party followed by communicating the requested personal grid results to the second party upon receipt of the cost from the second party. Next, a royalty fee for the first party is calculated based on the cost of the request for access to the personal grid results from the second party and then the royalty fee is paid to the first party.

In an embodiment, there is a system for determining authorization for a second party to access personal grid results. In one embodiment, there is a system embodied on a computing device having a processor for determining authorization for a second party, the system comprising: a storing system that stores personal grid results, wherein the personal grid results comprise genetic sequences or genetic markers of a patient, one or more proteomic profiles of the patient, one or more transcriptome profiles of the patient, or one or more cytogenetic data of the patient. The system also comprises a processing system configured for receiving a request from the second party to access personal grid results, wherein the personal grid results originated from a first party and are stored in a centralized database; and an access control system configured for determining whether the second party is authorized to access the personal grid results based on stored access rights, wherein the stored access rights comprise access to the personal grid results based on an appropriate payment for the personal grid results requested by the second party or denied access to the personal grid results based on non-payment or insufficient payment for the personal grid results requested by the second party. In another embodiment, payment is not required for the personal grid results. For example, some first parties may take a non-proprietary approach toward the personal grid results. In another embodiment, the first party always has controlled access to the personal grid results.

In one embodiment, the present invention is directed to a method in a clinical computing environment for communicating a personal grid result for a patient. In one embodiment, there is one or more computer-storage media storing computer-useable instructions that, when used by one or more computing devices, cause the one or more computing devices to perform a method in a clinical computing environment for communicating a personal grid result for a patient, comprising: receiving the personal grid results for the patient from a publisher. The personal grid results comprise one or more of: 1.) genetic sequences or genetic markers of a genome of the patient, 2.) one or more proteomic profiles of the patient, 3.) one or more genetic sequences or genetic markers of a microbiome of the patient, 4.) one or more transcriptome profiles of the patient, 5.) genetic sequences or genetic markers of a exome of the patient, and 6.) one or more cytogenetic data of the patient. The method also includes storing the personal grid results from the publisher in a centralized database followed by receiving a request for access to the personal grid results from a subscriber. Subsequently, a cost for access of the subscriber to the requested personal grid results is calculating based on the request. The method further includes communicating the cost for the requested personal grid results to the subscriber followed by communicating the requested personal grid results to the subscriber upon receipt of the cost from the subscriber. Next, a royalty fee for the publisher is calculated based on the cost of the request for access to the personal grid results from the subscriber and then the royalty fee is paid to the publisher.

In one embodiment, the subscription process should have the potential to be invisible to the user. For example, an asthma decision support application needs access to a set of SNPs associated with albuterol response. The application becomes the subscriber, interrogates the grid, finds the data that it needs and informs the clinician. The application, not the end user, manages the accounting by accruing usage of the personal grid results.

### BRIEF DESCRIPTION OF THE DRAWINGS

FIG. 1 is a schematic diagram of a suitable computing system environment for use in implementing the present invention;

FIG. 2 illustrates a personal grid;

FIG. 3 is a flow diagram illustrating one transaction method for personal grid results;

FIG. 4 is a schematic of a health care environment for use in implementing the present invention; and

FIG. 5 is a flow diagram illustrating one transaction method for personal grid results.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As one skilled in the art will appreciate, embodiments of our invention may be embodied as, among other things: a system and methods. Accordingly, the embodiments may take the form of a hardware embodiment, a software embodiment, or an embodiment combining software and hardware. In one embodiment, the invention takes the form of a computer-program product that includes computer-usable instructions embodied on one or more computer-readable media.

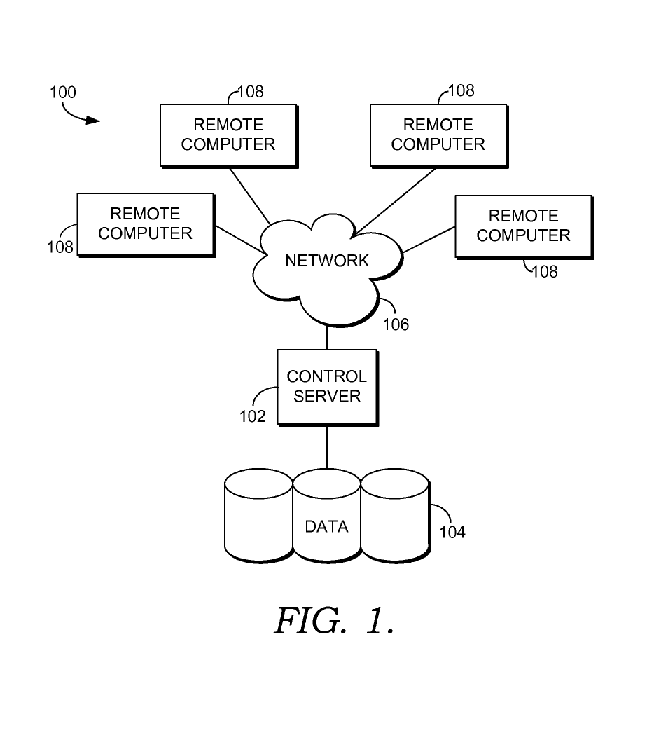

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

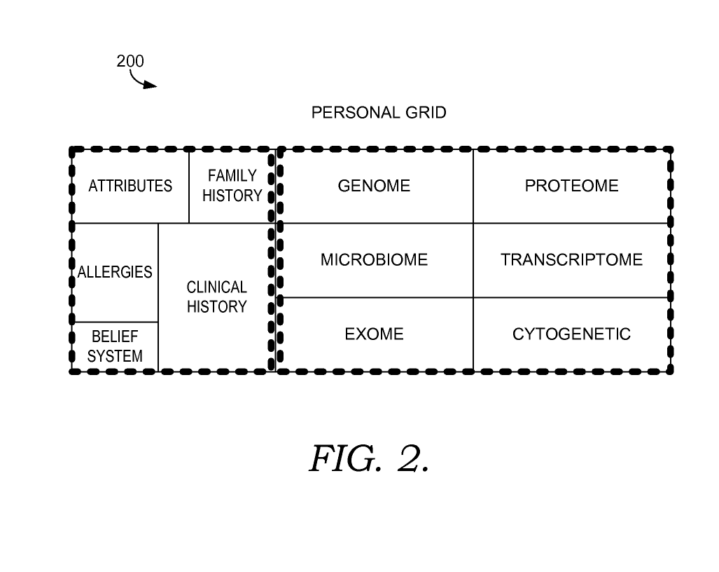

Turning now to FIG. 2, personal grid results are illustrated 200. In one embodiment, the personal grid results comprise one or more of: 1.) genetic sequences of a genome of the patient, 2.) one or more proteomic profiles of the patient, 3.) one or more genetic sequences of a microbiome of the patient, 4.) one or more transcriptome profiles of the patient, 5.) genetic sequences of a exome of the patient, and 6.) one or more cytogenetic data of the patient. In one embodiment, single-nucleotide polymorphisms (SNPs) can be found in both non-coding DNA and coding DNA, including genes. In one embodiment, the personal grid results also comprise clinical history, allergies, family history, a belief system, and attributes of the patient. In an embodiment, the clinical history, allergies, family history, a belief system, and attributes of the patient can be obtained from the patient's EMR and/or directly from the patient. In one embodiment, attributes of the patient include the patient's age, weight, gender, exercise management, diet and the like. Additionally, in an embodiment, the personal grid results are for more than one person.

In one embodiment, the human genome comprises all the human genetic information that is stored as DNA sequences within the 23 chromosome pairs of the cell nucleus and includes the DNA sequences within the mitochondrion. In an additional embodiment, any DNA sequences can be annotated or in raw sequence form.

In an embodiment, the human proteome comprises all of the proteins produced by the DNA sequences translated from the human genome. Since different sets of genes of the human genome are expressed according to the cell type at a given time and under defined conditions, the human proteome can be broken down into proteomic profiles. That is, proteomic profiles are the proteins expressed by the genome in a given cell type at a given time and under defined conditions. Defined conditions can be thought of as environmental conditions of the particular cell type at a given time, such as exposure to a particular hormone. Unlike the inherited genome, the proteome is dynamic and varies by time and specimen type, such as blood, saliva, urine, cerebrospinal fluid, and the like.

In an embodiment, the human microbiome comprises the aggregate of microorganisms that live within and on the human body and includes the genomes of the microorganisms along with their environmental interactions in a particular environment. These can include bacteria, viruses, fungi and other phyla of microorganisms.

In one embodiment, the human transcriptome comprises the set of all RNA molecules produced within one or a population of cells at a given point in time. The set of RNA molecules includes mRNA, rRNA, tRNA, and other non-coding RNA molecules. Since different sets of genes of the human genome are expressed according to the cell type at a given time and under defined conditions, the human transcriptome can be broken down into transcriptome profiles. That is, transcriptome profiles are the RNAs transcribed by the genome in a given cell type at a given time and under defined conditions. Defined conditions can be thought of as environmental conditions of the particular specimen type at a given time, such as exposure to a particular hormone.

In an embodiment, the human exome comprises the exons of the genome. Exons are the coding part of a gene. In particular, exons comprise the nucleotide sequences encoded by genes that remain present within the final mature RNA product of that gene after introns have been removed by RNA splicing. The term exon refers to both the DNA sequence within a gene and to the corresponding sequence in RNA transcripts. In RNA splicing, introns are removed and exons are covalently joined to one another as part of generating the mature mRNA or noncoding RNA product of a gene. The exon is ultimately translated into a polypeptide. Exome sequencing allows laboratories to reduce the cost of testing and analysis by focusing on approximately 1-3% of the genome.

In one embodiment, cytogenetics is the study of heredity and variation by the methods of both cytology and genetics. In particular, cytogenetics consists of the study of the structure and function of the cell, especially the chromosomes. In regards to cytogenetic study of the chromosomes, there are a multitude of experiments to study the structure and function of the chromosomes. Such experiments include routine analysis of G-banded chromosomes and other cytogenetic banding techniques, as well as molecular cytogenetic techniques such as fluorescent in situ hybridization (FISH) and comparative genomic hybridization (CGH).

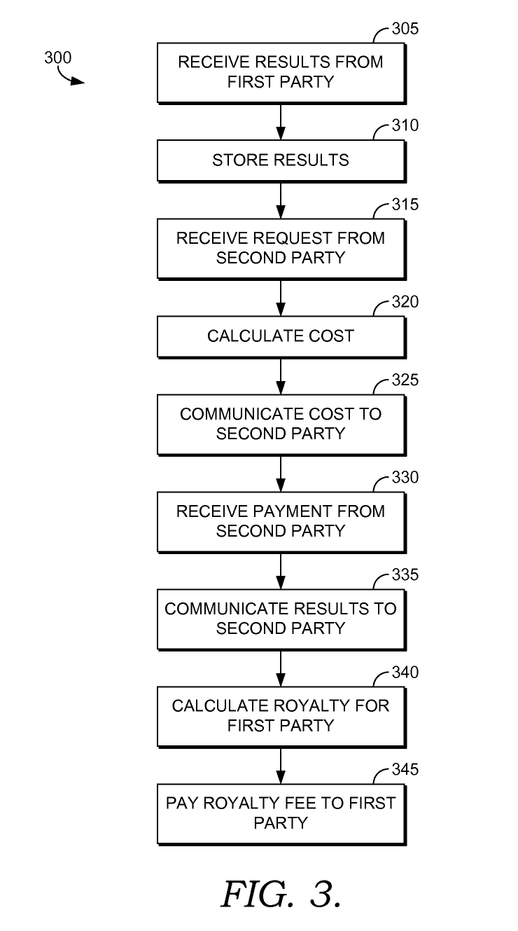

Turning now to FIG. 3, one personal grid results method 300 is illustrated as a block diagram. At step 305, the entity that is responsible for distributing personal grid results to a second party first receives the personal grid results from a first party. In one embodiment, the personal grid results comprise one or more of: 1.) genetic sequences or genetic markers of a genome of the patient, 2.) one or more proteomic profiles of the patient, 3.) one or more genetic sequences or genetic markers of a microbiome of the patient, 4.) one or more transcriptome profiles of the patient, 5.) genetic sequences or genetic markers of a exome of the patient, and 6.) one or more cytogenetic data of the patient.

At step 310, the personal grid results are stored by the entity that is responsible for distributing personal grid results to a second party in a centralized database. In one embodiment, a centralized database can include a cloud-based repository. At step 315, a request for personal grid results is received from a second party. At step 320, a cost for the second party to pay to the entity that is responsible for distributing personal grid results to the second party is calculated. In one embodiment, the cost is calculated based on what personal grid results are communicated to the second party. In an embodiment, the method further includes communicating the cost for the requested personal grid results to the second party 325 followed by communicating the requested personal grid results to the second party 335 upon receipt of the cost from the second party 330. Next, a royalty fee for the first party is calculated based on the cost of the request for access to the personal grid results from the second party 340 and then the royalty fee is paid to the first party 345.

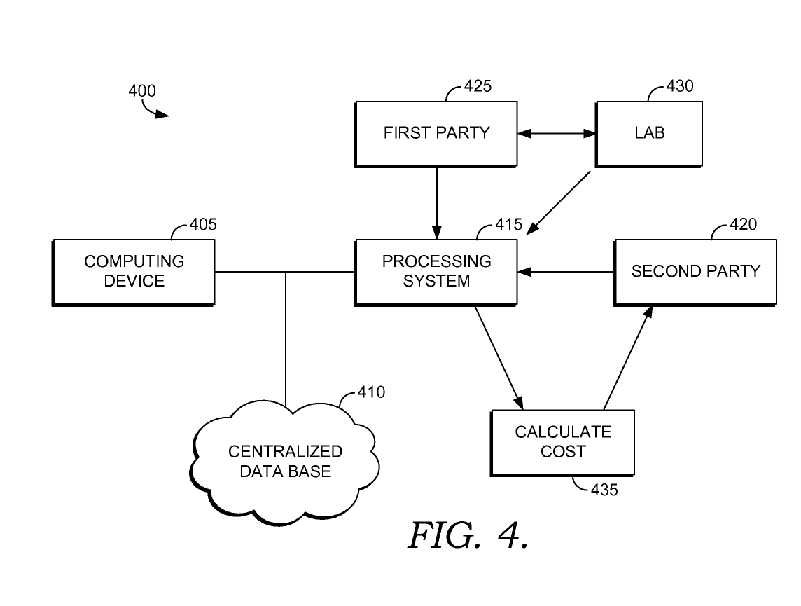

Turning to FIG. 4, a system 400 embodied on a computing device 405 for determining authorization for a second party to access personal grid results is illustrated. In one embodiment, the computing device has a processor. In an embodiment, the system comprises a storing system that stores personal grid results, wherein the personal grid results comprise genetic sequences of the patient, one or more proteomic profiles of the patient, one or more transcriptome profiles of the patient, and one or more cytogenetic data of the patient. In one embodiment, the genetic sequences of the patient comprise the genetic sequences of the genome of the patient, the one or more genetic sequences of the microbiome of the patient, and one or more genetic sequences of the exome of the patient. In one embodiment, the personal grid results also comprise clinical history, allergies, family history, a belief system, and attributes of the patient. In an embodiment, the clinical history, allergies, family history, a belief system, and attributes of the patient can be obtained from the patient's EMR and/or directly from the patient. In one embodiment, attributes of the patient include the patient's age, weight, gender, exercise management, diet and the like. In one embodiment, the storing system can be a cloud-based repository or a centralized database 410.

A processing system 415 receives a request from a second party 420 to access personal grid results, wherein the personal grid results originated from a first party 425 and are stored in the centralized database 410. In one embodiment, the personal grid results come directly from the first party 425. In an embodiment, the personal grid results come from a laboratory 430, wherein the personal grid results can be directly communicated to the processing system or communicated to the first party 425 who then communicates the results to the processing system 415. In one embodiment, the first party 425 requests personal grid results from the laboratory 430. Next, at step 435, a cost for the second party 420 to access the requested personal grid results is calculated and then that cost is communicated to the second party 420. In one embodiment, it is then determined whether the second party 420 is authorized to access the personal grid results based on stored access rights, wherein the stored access rights comprise access to the personal grid results based on an appropriate payment for the personal grid results requested by the second party 420 and denied access to the personal grid results based on non-payment or insufficient payment for the personal grid results requested by the second party 420. In an embodiment, the access control system is also configured to determine when to notify the second party of the availability of the personal grid results. In one embodiment, the access control system is also configured to determine when to require the second party 420 to access the personal grid results and when to verify the review of the personal grid results.

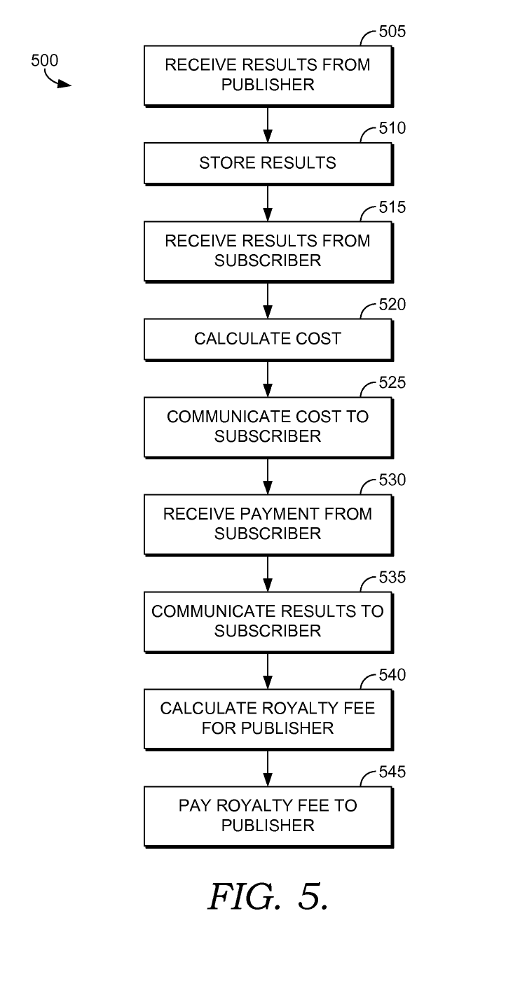

Turning now to FIG. 5, one personal grid results method 500 is illustrated as a block diagram. At step 505, the entity that is responsible for distributing personal grid results to a subscriber first receives the personal grid results from a publisher. In one embodiment, the personal grid results comprise one or more of: 1.) genetic sequences of a genome of the patient, 2.) one or more proteomic profiles of the patient, 3.) one or more genetic sequences of a microbiome of the patient, 4.) one or more transcriptome profiles of the patient, 5.) genetic sequences of a exome of the patient, and 6.) one or more cytogenetic data of the patient.

At step 510, the personal grid results are stored by the entity that is responsible for distributing personal grid results to the subscriber in a centralized database. In one embodiment, a centralized database can include a cloud-based repository. At step 315, a request for personal grid results is received from the subscriber. At step 320, a cost for the subscriber to pay to the entity that is responsible for distributing personal grid results to the subscriber is calculated. In one embodiment, the cost is calculated based on what personal grid results are communicated to the subscriber. In an embodiment, the method further includes communicating the cost for the requested personal grid results to the subscriber 325 followed by communicating the requested personal grid results to the subscriber 335 upon receipt of the cost from the subscriber 330. Next, a royalty fee for the publisher is calculated based on the cost of the request for access to the personal grid results from the subscriber 340 and then the royalty fee is paid to the publisher 345.

What is claimed is:

1. One or more computer-storage media storing computer-useable instructions that, when used by one or more computing devices, cause the one or more computing devices to perform a method in a clinical computing environment for communicating a personal grid result for a patient, comprising:
receiving the personal grid results for the patient from a first party, wherein the results comprise one or more of:
(a) genetic sequences or genetic markers of a genome of the patient;
(b) one or more proteomic profiles of the patient;
(c) one or more genetic sequences or genetic markers of a microbiome of the patient;
(d) one or more transcriptome profiles of the patient;
(e) genetic sequences or genetic markers of a exome of the patient; and
(f) one or more cytogenetic data of the patient;
storing the personal grid results from the first party in a centralized database;
receiving a request for access to the personal grid results from a second party;
calculating a cost for access of the second party to the requested personal grid results using the request;
communicating the cost for the requested personal grid results to the second party;
communicating the requested personal grid results to the second party upon receipt of the cost from the second party;
calculating a royalty fee for the first party based on the cost of the personal grid results communicated to the second party; and
paying the royalty fee to the first party.

2. The method of claim 1, wherein the personal grid results also comprise clinical history, allergies, family history, a belief system, and attributes of the patient.

3. The method of claim 1, wherein the personal grid results are for more than one patient.

4. The method of claim 1, wherein calculating the cost is proportional to the volume of data accessed by the second party.

5. The method of claim 1, wherein calculating the cost is based on communicating one or more non-coding DNA sequences to the second party.

6. The method of claim 1, wherein calculating the cost is based on communicating one or more SNPs associated with one or more genes to the second party.

7. The method of claim 1, wherein calculating the cost is based on communicating one or more genetic markers associated with a specific phenotype to the second party.

8. The method of claim 1, wherein calculating the cost is based on communicating one or more genetic markers associated with a specific genotype to the second party.

9. The method of claim 1, wherein calculating the cost is based on communicating a partial gene sequence to the second party.

10. The method of claim 1, wherein calculating the cost is based on communicating the genome of the patient to the second party.

11. The method of claim 1, wherein calculating the cost is based on communicating a microbiome profile of the patient to the second party.

12. The method of claim 1, wherein calculating the cost is based on communicating a partial genetic sequence of the exome of the patient to the second party.

13. The method of claim 1, wherein calculating the cost is based on communicating one or more haplotypes of the patient to the second party.

14. The method of claim 1, wherein calculating the cost is based on communicating a partial sequence of the patient's genome to the second party.

15. A system embodied on a computing device having a processor for determining authorization for a second party to access personal grid results, the system comprising:
a storing system that stores personal grid results, wherein the personal grid results comprise genetic sequences of a patient, one or more proteomic profiles of the patient, one or more transcriptome profiles of the patient, and one or more cytogenetic data of the patient;
a processing system configured for:
receiving a request from the second party to access the personal grid results, wherein the personal grid results originated from a first party and are stored in a centralized database;
calculating a cost for the second party for accessing requested personal grid results;
communicating the cost to the second party for accessing the requested personal grid results; and
determining whether the second party is authorized to access the personal grid results based on stored access rights, wherein the stored access rights comprise:
(a) access to the personal grid results based on an appropriate payment for the personal grid results requested by the second party; and
(b) denied access to the personal grid results based on non-payment or insufficient payment for the personal grid results requested by the second party.

16. The system of claim 15, wherein the genetic sequences of the patient comprise the genetic sequences of the genome of the patient, the one or more genetic sequences of the microbiome of the patient, and the one or more genetic sequences of the exome of the patient.

17. The system of claim 15, wherein the access control system is also configured to determine when to notify the second party of the availability of personal grid results.

18. The system of claim 15, wherein the access control system is also configured to determine when to require the second party to access the personal grid results and when to verify the review of the personal grid results.

19. The system of claim 15, wherein the personal grid results also comprise clinical history, allergies, family history, a belief system, and attributes of the patient.

20. One or more computer-storage media storing computer-useable instructions that, when used by one or more computing devices, cause the one or more computing devices to perform a method in a clinical computing environment for communicating a personal grid result for a patient, comprising:
receiving the personal grid results for the patient from a publisher, wherein the results comprise one or more of:
(a) genetic sequences or genetic markers of a genome of the patient;
(b) one or more proteomic profiles of the patient;
(c) one or more genetic sequences or genetic markers of a microbiome of the patient;
(d) one or more transcriptome profiles of the patient;
(e) genetic sequences or genetic markers of a exome of the patient; and
(f) one or more cytogenetic data of the patient;
storing the personal grid results from the publisher in a centralized database;
receiving a request for access to the personal grid results from a subscriber;
calculating a cost for access of the subscriber to the requested personal grid results using the request;
communicating the cost for the requested personal grid results to the subscriber;
communicating the requested personal grid results to the subscriber upon receipt of the cost from the subscriber;
calculating a royalty fee for the publisher based on the cost of the personal grid results communicated to the subscriber; and
paying the royalty fee to the publisher.
